(19) United States
(12) Patent Application Publication
(10) Pub. No.: US 2026/0021935 A1
(43) Pub. Date: Jan. 22, 2026

(54) Modular Units Including Handles with Latch Control

(71) Applicant: Milwaukee Electric Tool Corporation, Brookfield, WI (US)

(72) Inventors: Jacob R. Wenzlick, Milwaukee, WI (US); Kyle R. Becker, Brookfield, WI (US); Alec C. Roberts, Milwaukee, WI (US)

(21) Appl. No.: 19/237,475

(22) Filed: Jun. 13, 2025

Related U.S. Application Data
(60) Provisional application No. 63/673,283, filed on Jul. 19, 2024.
(60) Provisional application No. 63/685,020, filed on Aug. 20, 2024.

(51) Int. Cl. B65D 21/02; B65D 25/28; B65D 43/22

(52) U.S. Cl. CPC B65D 21/0228; B65D 25/2841; B65D 43/22

(57) ABSTRACT

Various latch assemblies are provided to facilitate engaging and disengaging utility modules within a modular system. The latch assemblies permit users to actuate latches from an extended position to a retracted position, thereby permitting disengagement of the utility modules, while the hand of the user is in position to hold the now decoupled utility module.

### CROSS-REFERENCE TO RELATED PATENT APPLICATIONS

The present application claims the benefit of and priority to U.S. Provisional Application No. 63/685,020, filed on Aug. 20, 2024 and U.S. Provisional Application No. 63/673,283, filed on Jul. 19, 2024, each which is incorporated herein by reference in its entirety.

### BACKGROUND OF THE INVENTION

The present disclosure is directed generally to the field of containers and related devices. The present disclosure relates specifically to coupling structures configured to detachably and rigidly couple utility modules (e.g., storage utility modules) within a modular system.

Tool storage utility modules are often used to transport tools and tool accessories. Some storage utility modules are designed to incorporate into a modular storage system. Various coupling structures can be configured to facilitate decoupling utility modules within a modular system while also grasping and holding a handle for transporting the utility module.

### SUMMARY OF THE INVENTION

One embodiment of the invention relates to a utility module including a housing extending from a front to a rear, a bottom surface defined by the housing, a plurality of male couplers extending from the bottom surface, the plurality of male couplers configured to detachably and rigidly couple the housing to a second utility module, a latch slidably coupled to the front of the housing, the latch actuating between an extended position and a retracted position with respect to the bottom surface, and an interface coupled to the housing. The interface is coupled to the latch such that a user directly engages the interface to actuate the latch between the extended position and the retracted position, and the entire interface is positioned in front of an exterior forward-facing surface of the housing.

Another embodiment of the invention relates to a utility module including a housing extending from a front to a rear, a bottom surface defined by the housing, a plurality of male couplers extending from the bottom surface, the plurality of male couplers configured to detachably and rigidly couple the housing to a second utility module, a latch slidably coupled to the front of the housing, the latch actuating between an extended position and a retracted position with respect to the bottom surface, an interface coupled to the housing, and a handle coupled to the front of the housing. The handle rotates with respect to the housing about an axis, and the interface is positioned higher than the axis. The interface is coupled to the latch such that a user directly engages the interface to actuate the latch between the extended position and the retracted position.

Another embodiment of the invention relates to a utility module including a housing extending from a front to a rear, a bottom surface defined by the housing, a plurality of male couplers extending from the bottom surface, the plurality of male couplers configured to detachably and rigidly couple the housing to a second utility module, a latch slidably coupled to the front of the housing, the latch actuating between an extended position and a retracted position with respect to the bottom surface, and an interface coupled to the housing. The interface is coupled to the latch such that a user directly engages the interface to actuate the latch between the extended position and the retracted position. The interface defines an inner surface that faces in part towards the rear of the housing.

Another embodiment of the invention relates to a utility module including a housing extending from a front to a rear, a bottom surface defined by the housing, a plurality of male couplers extending from the bottom surface, a latch slidably coupled to the front of the housing, and an interface coupled to the housing. Each of the plurality of male couplers extend from the bottom surface and include a body extending downward from the bottom surface, a first tongue and a second tongue extending from the body away from each other. The first tongue is offset from the bottom surface to define a first channel, and the second tongue is offset from the bottom surface to define a second channel. The latch actuates between an extended position and a retracted position with respect to the bottom surface. The interface is coupled to the latch such that a user actuating the interface actuates the latch between the extended position and the retracted position. The interface is positioned in front of an exterior forward facing surface of the housing.

In various embodiments, the utility module includes a handle coupled to the front of the housing, and the handle rotates with respect to the housing about an axis, and the interface is positioned higher than the axis when the bottom surface of the housing is facing downward. In various embodiments, the interface is positioned in front of the bottom surface of the housing. In various embodiments, no portion of the bottom surface is positioned directly below the interface. In various embodiments, the interface is positioned in front of the latch.

Additional features and advantages will be set forth in the detailed description which follows, and will be readily apparent to those skilled in the art from the description or recognized by practicing the embodiments as described in the written description and/or shown in the accompany drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments. In addition, alternative exemplary embodiments relate to other features and combinations of features as may be generally recited in the claims.

### BRIEF DESCRIPTION OF THE DRAWINGS

This application will become more fully understood from the following detailed description, taken in conjunction with the accompanying figures, wherein like reference numerals refer to like elements in which:

FIG. 1 is a perspective view from above of a utility assembly system, according to an exemplary embodiment.

FIG. 2 is a perspective view of a utility module including a latch assembly, according to an exemplary embodiment.

FIG. 3 is a perspective view of the latch assembly of FIG. 2, according to an exemplary embodiment.

FIG. 4 is a front view of the latch assembly of FIG. 2, according to an exemplary embodiment.

FIG. 5 is a perspective view of a latch assembly, according to another exemplary embodiment.

FIG. 6 is a front view of the latch assembly of FIG. 5, according to an exemplary embodiment.

FIG. 7 is a perspective view of a portion of the latch assembly of FIG. 5, according to an exemplary embodiment.

FIG. 8 is a perspective view of a utility module including a latch assembly, according to another exemplary embodiment.

FIG. 9 is a perspective view of the latch assembly of FIG. 8, according to another exemplary embodiment.

FIG. 10 is a front view of the latch assembly of FIG. 8, according to an exemplary embodiment.

FIG. 11 is a front view of a latch assembly, according to another exemplary embodiment.

FIG. 12 is a rear view of the latch assembly of FIG. 11, according to an exemplary embodiment.

FIG. 13 is a front view of the latch assembly of FIG. 11, according to an exemplary embodiment.

FIG. 14 is a rear view of the latch assembly of FIG. 11, according to an exemplary embodiment.

FIG. 15 is a perspective view of a female coupler in a utility module of the utility module assembly of FIG. 1, according to an exemplary embodiment.

FIG. 16 is a perspective view of a utility module of the utility module assembly of FIG. 1, according to an exemplary embodiment.

FIG. 17 is a perspective view of a male coupler of the utility module of FIG. 16, according to an exemplary embodiment.

### DETAILED DESCRIPTION

Referring generally to the figures, various embodiments of utility modules are shown for modular systems including handles that facilitate users actuating latches. In various modular systems, a latch extends from one utility module and interfaces with another utility module to rigidly couple the utility modules together, such as the latch and various couplers cooperatively rigidly coupling the utility modules. Generally, before the utility modules can be decoupled, the latch is actuated to a retracted position. Applicant has developed several handles that facilitate the user holding a utility module in preparation for transport, and actuating an interface coupled to the handle that retracts the latch. As a result, the user can decouple the latch and immediately begin transporting the utility module without having to adjust the position of the user's hands on the utility module as may be needed to actuate a latch with an interface located elsewhere on the container.

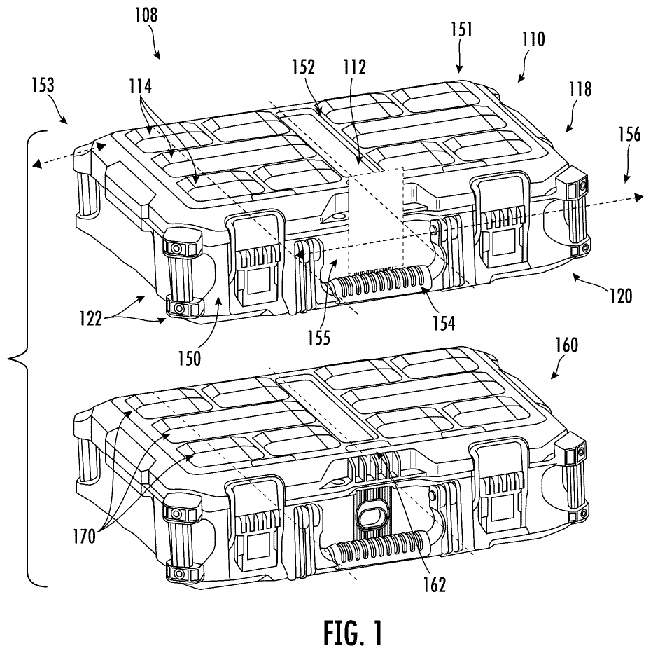

Referring to FIG. 1, various aspects of utility assembly system 108 are shown. Utility assembly system 108 includes utility module 110 and utility module 160.

Utility module 110 and utility module 160 are detachably and rigidly coupled together. Utility module 110 includes housing 118 extending from front 150 to rear 151, and lid 152 pivotally coupled to housing 118 such that lid 152 pivots about axis 153 with respect to housing 118 proximate rear 151 of housing 118.

Utility module 110 includes female couplers 114 defined by lid 152, male couplers 122 extending from bottom surface 120 defined by housing 118, and latch assembly 112, which is shown schematically in FIG. 1. In various embodiments, latch assembly 112 includes a latch that projects below bottom surface 120 of housing 118.

Utility module 110 includes handle 154 coupled to housing 118, such as pivotally coupled such that handle 154 pivots about handle axis 156 with respect to housing 118. In various embodiments, handle 154 is positioned in front of and/or coupled to exterior front surface 155 of housing 118.

Utility module 160 includes female couplers 170 and latch recess 162. In use, utility module 110 is detachably and rigidly coupled to utility module 160 via male couplers 122 engaging with female couplers 170, such as slidingly engaging, and a latch of latch assembly 112 engaging with latch recess 162 to bias male couplers 122 and female couplers 170 from disengaging, such as to prevent sliding disengagement.

In various embodiments, the interface of the latch assembly 112 (e.g., interface 220, 270, 320, or 370) is positioned higher than the axis 156 of rotation of handle 154 when bottom surface 120 defined by housing 118 is facing downward. In various embodiments, the interface of the latch assembly 112 is positioned in front of the bottom surface 120 of the housing 118. In various embodiments, no portion of the bottom surface 120 is positioned directly below the interface of the latch assembly 112. In various embodiments, the interface of the latch assembly 112 is positioned in front of the latch of the latch assembly 112.

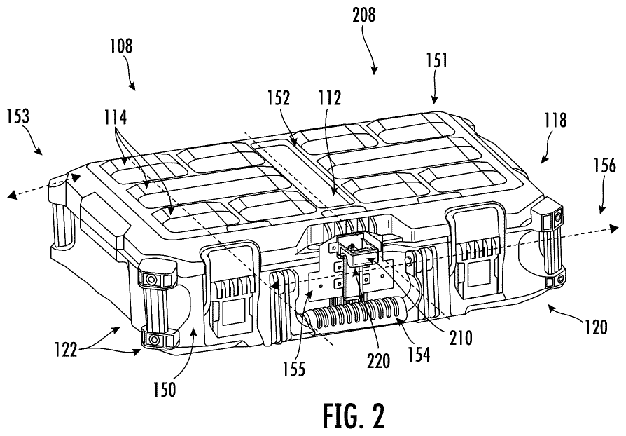

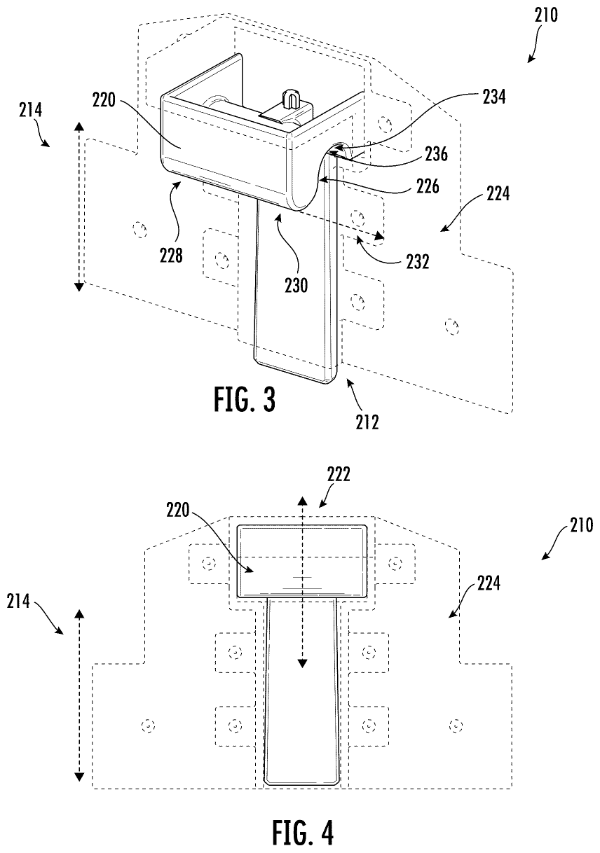

Referring to FIGS. 2-4, various aspects of utility module 208 including latch assembly 210 are shown. Utility module 208 is structurally and functionally the same as utility module 110, except utility module 208 includes latch assembly 210. In various embodiments of utility module 110, utility module 110 includes latch assembly 210 as latch assembly 112.

In various embodiments, utility module 208 includes housing 118 extending from a front 150 to a rear 151, a bottom surface 120 defined by the housing 118, a plurality of male couplers 122 extending from the bottom surface 120, a latch 212 slidably coupled to the front 150 of the housing 118, the latch 212 actuating between an extended position and a retracted position with respect to the bottom surface 120, and an interface 220 coupled to the housing 118. Interface 220 is coupled to the latch 212 such that a user directly engages the interface 220 to actuate the latch 212 between the extended position and the retracted position. In various embodiments, the interface 220 is positioned in front of an exterior forward-facing surface 155 of the housing 118, such as the entire interface 220 is positioned in front of an exterior forward-facing surface 155 of the housing 118. In various embodiments, interface 220 defines an inner surface 226 that faces in part towards the rear 151 of housing 118. In various embodiments, the plurality of male couplers 122 are configured to detachably and rigidly couple the housing 118 to a second utility module (e.g., utility module 160).

Latch assembly 210 includes latch 212 that slidably retracts and extends along axis 214. Latch assembly 210 includes plate 224 and interface 220 slidably coupled to plate 224 such that interface 220 slides along axis 222 with respect to plate 224.

In various embodiments, latch assembly 210 is coupled to housing 118 of utility module 208, such as to the front 150 of housing 118 such that plate 224 defines exterior front surface 155 of utility module 208. In this configuration, latch 212 of latch assembly 210 retractably extends below bottom surface 120 of housing 118.

In use, a user grasps and holds latch assembly 210 such as by placing their fingers against interface 220. The user actuates interface 220 along axis 222 to actuate latch 212 from the extended position to the retracted position. When latch 212 is in the retracted position, male couplers 122 of utility module 208 are permitted to disengage, such as by slidingly disengaging, from female couplers 170 of utility module 160. The user can then hold interface 220 to facilitate moving the utility module 208 that includes latch assembly 210.

In various embodiments, interface 220 defines an inner surface 226 that faces towards the housing 118. In various embodiments, the interface 220 defines a downward-facing convex surface 230, such as projection 228 defining downward-facing convex surface 230.

In various embodiments, at least a portion of the downward-facing convex surface 230 extends linearly along an axis 232 parallel to the exterior forward-facing surface 155 of the housing 118. In various embodiments, at least a portion of the downward-facing convex surface 230 extends linearly along an axis 232 parallel to the bottom surface 120.

In various embodiments, interface 220 is slidably coupled to the housing 118. In various embodiments, interface 220 slides along axis 214 parallel to the exterior forward-facing surface 155 of housing 118. In various embodiments, axis 214 is vertical and interface 220 slides vertical axis 214.

In various embodiments, interface 220 define a projection 228 and a recess 234, the projection 228 extending past the recess 234 and the recess 234 is between the projection 228 and the housing 218. In various embodiments, the projection 228 extends lower than the recess 234. In various embodiments, the recess 234 defines a downward-facing concave surface 236.

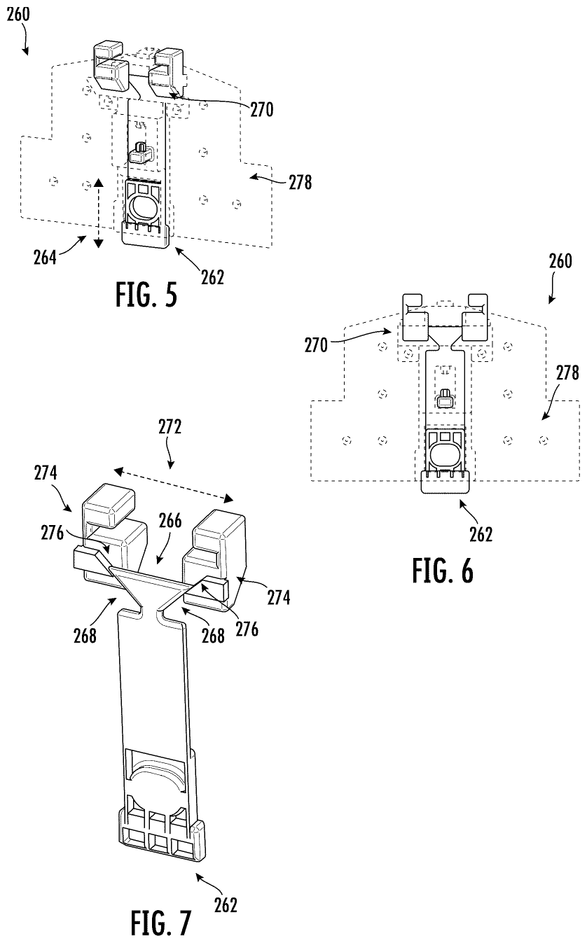

Referring to FIGS. 5-7, various aspects of latch assembly 260 are shown. Latch assembly 260 is substantially the same as latch assembly 210 except for the differences discussed herein. In various embodiments of utility module 110, utility module 110 includes latch assembly 260 as latch assembly 112.

In various embodiments, latch assembly 260 is coupled to housing 118 of utility module 110, such as to the front 150 of housing 118 such that plate 278 defines exterior front surface 155 of utility module 110. In this configuration, latch 262 of latch assembly 260 retractably extends below bottom surface 120 of housing 118.

In use, a user grasps and holds latch assembly 260 such as by placing their fingers against interface 270. The user actuates latch 262 upward along axis 264 by squeezing together arms 274 along axis 272 towards each other. When arms 274 are moved towards each other, interface surfaces 276 of arms 274 interface with interfaces surfaces 268 of projection 266 to move projection 266, and thus also latch 262, upward along axis 264. As a result, latch 262 actuates along axis 264 from the extended position to the retracted position. When latch 262 is in the retracted position, male couplers 122 of utility module 110 are permitted to disengage, such as by slidingly disengaging, from female couplers 170 of utility module 160. The user can then hold interface 270 to facilitate moving the utility module 110 that includes latch assembly 260.

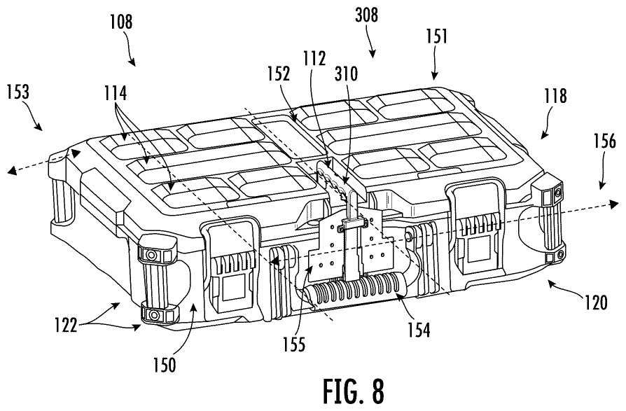

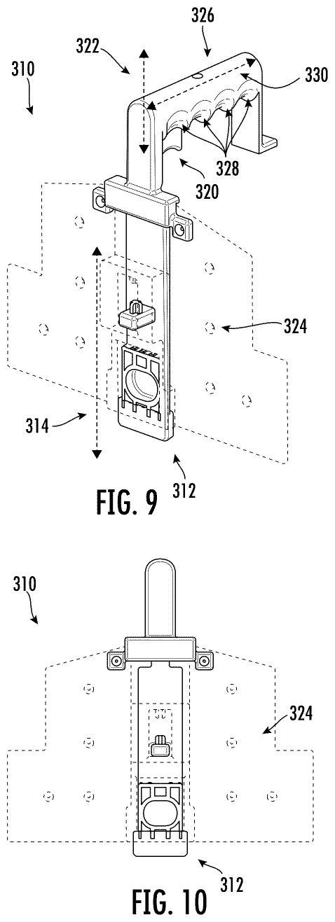

Referring to FIGS. 8-10, various aspects of utility module 308 including latch assembly 310 are shown. Latch assembly 310 is substantially the same as latch assembly 210 or latch assembly 260 except for the differences discussed herein. Utility module 308 is structurally and functionally the same as utility module 110, except utility module 308 includes latch assembly 310. In various embodiments of utility module 110, utility module 110 includes latch assembly 310 as latch assembly 112.

Latch assembly 310 includes latch 312 that slidably retracts and extends along axis 314. Latch assembly 310 includes plate 324 and interface 320 slidably coupled to plate 324 such that interface 320 slides along axis 322 with respect to plate 324.

In various embodiments, latch assembly 310 is coupled to housing 118 of utility module 308, such as to the front 150 of housing 118 such that plate 324 defines exterior front surface 155 of utility module 308. In this configuration, latch 312 of latch assembly 310 retractably extends below bottom surface 120 of housing 118.

In various embodiments, handle 326 is a generally horizontal structure extending away from the front face of the container (e.g., front surface 155 of utility module 308) towards the rear of the container. Handle 326 includes interface 320 extending below the lower surface of handle 326, that when actuated moves upwards towards and into handle 326.

In an alternate embodiment, handle 326 extends outward in front of the utility module, such as interface 320 being positioned in front of the bottom surface 120 of the housing 118.

In use, a user grasps and holds latch assembly 310 such as by placing their fingers against interface 320 and arcuate recesses 328 of handle 326 (e.g., by placing individual fingers within one or more of arcuate recesses 328). Applicant has observed that providing arcuate recesses 328 facilitates the user gripping handle 326. The user actuates interface 320 along axis 322 to actuate latch 312 along axis 314 from the extended position to the retracted position. When latch 312 is in the retracted position, male couplers 122 of utility module 308 are permitted to disengage, such as by slidingly disengaging, from female couplers 170 of utility module 160. The user can then hold interface 320 to facilitate moving the utility module 308 that includes latch assembly 310.

In various embodiments, interface 320 slides along an axis 322 parallel to an exterior forward-facing surface 155 of the housing 118.

In various embodiments, utility module 308 includes handle 326 extending rearward from the front of housing 118. In various embodiments, handle 326 defines a primary longitudinal axis 330 as the handle 326 extends from the housing 118.

In various embodiments, handle 326 includes a plurality of finger recesses 328 each of which are configured to receive a finger of the user. In various embodiments, the interface 320 is positioned within at least one of the finger recesses 328.

Referring to FIGS. 11-14, various aspects of latch assembly 360 are shown. Latch assembly 360 is substantially the same as latch assembly 210, latch assembly 260, or latch assembly 310 except for the differences discussed herein. In various embodiments of utility module 110, utility module 110 includes latch assembly 360 as latch assembly 112.

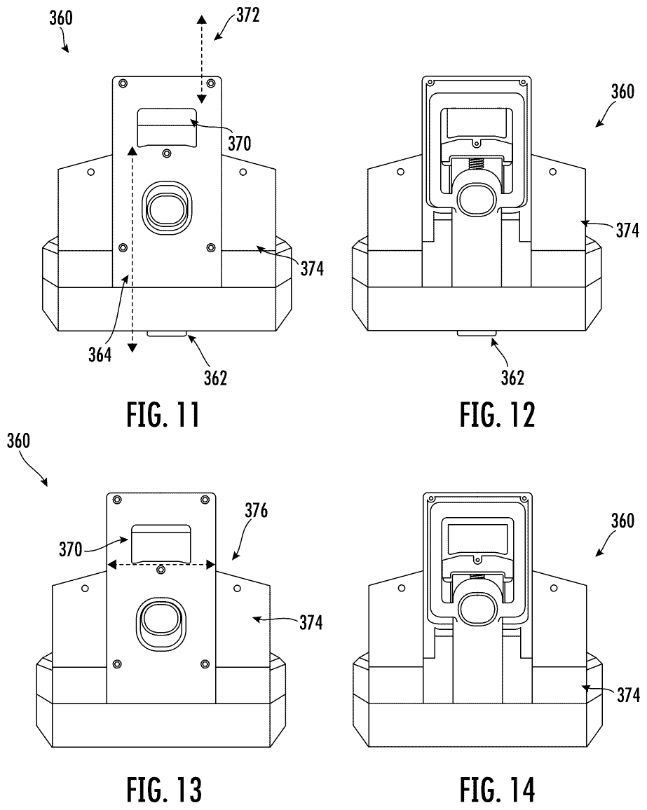

Latch assembly 360 includes latch 362 that slidably retracts and extends along axis 364. FIGS. 11-12 depict latch 362 in the extended position, and FIGS. 13-14 depict latch 362 in the retracted position. Latch assembly 360 includes plate 374 and interface 370 slidably coupled to plate 374 such that interface 370 slides along axis 372 with respect to plate 374.

In various embodiments, latch assembly 360 is coupled to housing 118 of utility module 110, such as to the front 150 of housing 118 such that plate 224 defines exterior front surface 155 of utility module 110. In this configuration, latch 362 of latch assembly 310 retractably extends below bottom surface 120 of housing 118.

In use, a user grasps and holds latch assembly 360 such as by placing their fingers against interface 370. The user actuates interface 370 along axis 372 to actuate latch 362 along axis 364 from the extended position to the retracted position. When latch 362 is in the retracted position, male couplers 122 of utility module 110 are permitted to disengage, such as by slidingly disengaging, from female couplers 170 of utility module 160. The user can then hold interface 370 to facilitate moving the utility module 110 that includes latch assembly 360.

In various embodiments, interface 370 is pivotally coupled to plate 374 such that interface pivots about axis 376 with respect to plate 374. In this way, interface 370 is pivotable when user is carrying utility module 110, thereby facilitating the grip of the user when carrying utility module 110.

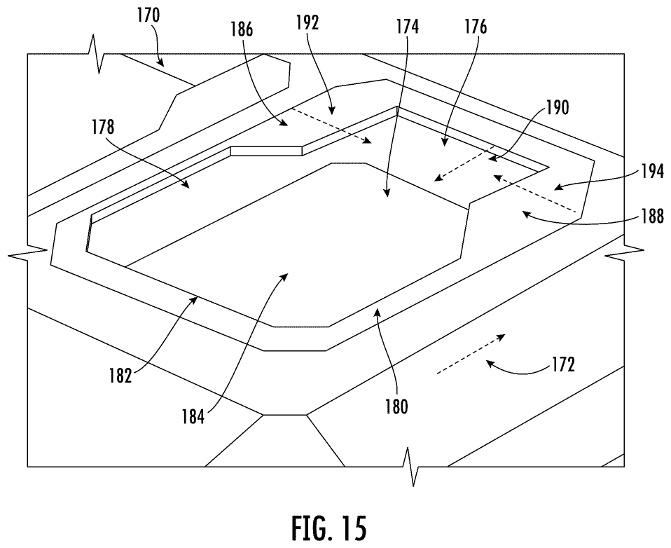

Referring to FIG. 15, various aspects of female couplers 170 are shown. In various embodiments female couplers 114 are structurally and functionally the same as female couplers 170.

Female coupler 170 includes a recessed surface 174. Backwall 176, opposing front wall 182, first sidewall 178, and opposing second sidewall 180 extend upward from recessed surface 174. Female coupler 170 includes a pocket 184 collectively defined by recessed surface 174, backwall 176, front wall 182, first sidewall 178, and second sidewall 180.

First rib 186 extends from backwall 176 and first sidewall 178 above pocket 184 and/or recessed surface 174. In particular, first rib 186 extends in direction 192 from first sidewall 178 and first rib 186 extends in direction 190 from backwall 176. Second rib 188 extends from backwall 176 and second sidewall 180 above pocket 184 and/or recessed surface 174. In particular, second rib 188 extends in direction 194 from second sidewall 180 and second rib 188 extends in direction 190 from backwall 176. To couple a male coupler to female coupler 170, the male coupler moves in direction 172 with respect to the female coupler 170 until one or more tongues of a male coupler are below ribs 186, 188, and a latch extends into latch recess (e.g., latch recess 162) thereby limiting sliding displacement of the object including the male coupler with respect to the respective utility module (e.g., utility module 160).

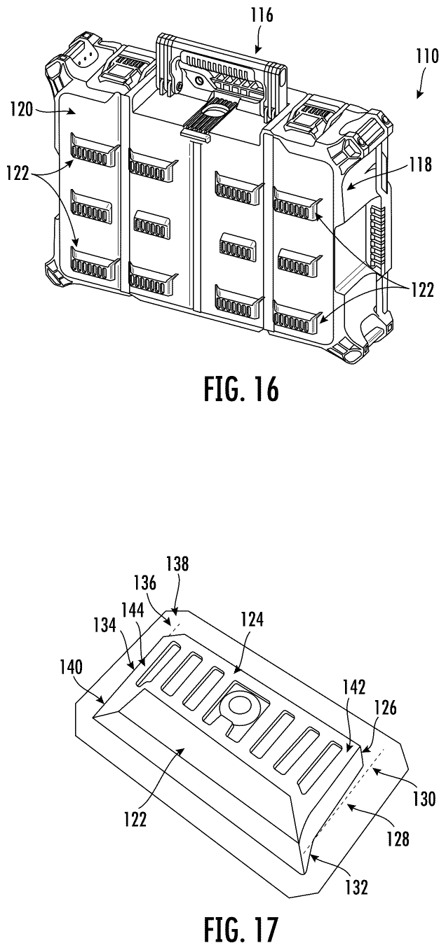

Referring to FIGS. 16-17, in various embodiments, utility module 110 includes one or more male couplers 122, such as a plurality of male couplers 122, that extend from bottom surface 120 of housing 118 and couple to female couplers 170. Each of the plurality of male couplers 122 includes a body 124 extending downward from bottom surface 120 of the utility module (e.g., utility module 110), a first tongue 126, and a second tongue 134. The first tongue 126 and the second tongue 134 extend from the body 124 away from each other and both are offset from and below the bottom surface 120, such as parallel to bottom surface 120. The first tongue 126 is offset from the bottom surface 120 to define a first channel 128 between bottom surface 120 and the first tongue 126, and the second tongue 134 is offset from the bottom surface 120 to define a second channel 136 between bottom surface 120 and the second tongue 134. The first channel 128 and second channel 136 each extend on opposing sides (e.g., first side 142 and opposing second side 144) of the body 124. Each of first channel 128 and second channel 136 includes a front open end and a back closed end. For example, first channel 128 includes a front open end 130 and a back closed end 132, and second channel 136 includes a front open end 138 and a back closed end 140.

In a specific embodiment, female couplers 114, male couplers 122, female couplers 170, latch recesses 162, and latches 212, 262, 312, 362 are compatible with the coupling mechanism(s) described in International Patent International Patent Publication No. WO/2017/191628, which is hereby incorporated by reference in its entirety.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature. As used herein, “rigidly coupled” refers to two components being coupled in a manner such that the components move together in a fixed positional relationship when acted upon by a force.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A utility module comprising:
a housing extending from a front to a rear;
a bottom surface defined by the housing;
a plurality of male couplers extending from the bottom surface, the plurality of male couplers configured to detachably and rigidly couple the housing to a second utility module;
a latch slidably coupled to the front of the housing, the latch actuating between an extended position and a retracted position with respect to the bottom surface; and
an interface coupled to the housing, wherein the interface is coupled to the latch such that a user directly engages the interface to actuate the latch between the extended position and the retracted position, wherein the entire interface is positioned in front of an exterior forward-facing surface of the housing.

2. The utility module of claim 1, each of the plurality of male couplers extending from the bottom surface and comprising a body extending downward from the bottom surface, a first tongue and a second tongue extending from the body away from each other, the first tongue offset from the bottom surface to define a first channel, the second tongue offset from the bottom surface to define a second channel.

3. The utility module of claim 1, wherein the interface defines an inner surface that faces in part towards the housing.

4. The utility module of claim 1, wherein the interface defines a downward-facing convex surface.

5. The utility module of claim 4, wherein at least a portion of the downward-facing convex surface extends linearly along an axis parallel to the exterior forward-facing surface of the housing.

6. The utility module of claim 4, wherein at least a portion of the downward-facing convex surface extends linearly along an axis parallel to the bottom surface.

7. The utility module of claim 1, wherein the interface is slidably coupled to the housing.

8. The utility module of claim 7, the interface sliding along an axis parallel to the exterior forward-facing surface of the housing.

9. A utility module comprising:
a housing extending from a front to a rear;
a bottom surface defined by the housing;
a plurality of male couplers extending from the bottom surface, the plurality of male couplers configured to detachably and rigidly couple the housing to a second utility module;
a latch slidably coupled to the front of the housing, the latch actuating between an extended position and a retracted position with respect to the bottom surface;
an interface coupled to the housing, wherein the interface is coupled to the latch such that a user directly engages the interface to actuate the latch between the extended position and the retracted position; and
a handle coupled to the front of the housing, wherein the handle rotates with respect to the housing about an axis, and wherein the interface is positioned higher than the axis.

10. The utility module of claim 9, each of the plurality of male couplers extending from the bottom surface and comprising a body extending downward from the bottom surface, a first tongue and a second tongue extending from the body away from each other, the first tongue offset from the bottom surface to define a first channel, the second tongue offset from the bottom surface to define a second channel.

11. The utility module of claim 9, the interface defining a projection and a recess, the projection extending past the recess and the recess is between the projection and the housing.

12. The utility module of claim 11, wherein the projection extends lower than the recess.

13. The utility module of claim 11, the recess defining a downward-facing concave surface.

14. The utility module of claim 9, wherein the interface is slidably coupled to the housing.

15. The utility module of claim 14, the interface sliding along a vertical axis.

16. The utility module of claim 14, the interface sliding along an axis parallel to an exterior forward-facing surface of the housing.

17. A utility module comprising:
a housing extending from a front to a rear;
a bottom surface defined by the housing;
a plurality of male couplers extending from the bottom surface, the plurality of male couplers configured to detachably and rigidly couple the housing to a second utility module;
a latch slidably coupled to the front of the housing, the latch actuating between an extended position and a retracted position with respect to the bottom surface; and
an interface coupled to the housing, wherein the interface is coupled to the latch such that a user directly engages the interface to actuate the latch between the extended position and the retracted position, wherein the interface defines an inner surface that faces in part towards the rear of the housing.

18. The utility module of claim 17, each of the plurality of male couplers extending from the bottom surface and comprising a body extending downward from the bottom surface, a first tongue and a second tongue extending from the body away from each other, the first tongue offset from the bottom surface to define a first channel, the second tongue offset from the bottom surface to define a second channel.

19. The utility module of claim 17, wherein the interface defines a downward-facing convex surface.

20. The utility module of claim 17, wherein the interface is slidably coupled to the housing, the interface sliding along an axis.
